(19) United States
(12) Patent Application Publication
(10) Pub. No.: US 2014/0331974 A1
(43) Pub. Date: Nov. 13, 2014

(54) Modular Low Pressure Fuel System with Filtration

(71) Applicant: CATERPILLAR INC., Peoria, IL (US)

(72) Inventors: Chad Ahmad, Peoria, IL (US); Steven Tian, Bloomington, IL (US); Scott Shafer, Morton, IL (US); Alan Stockner, Metamora, IL (US); David Hackett, Washington, IL (US)

(73) Assignee: Caterpillar Inc., Peoria, IL (US)

(21) Appl. No.: 13/889,594

(22) Filed: May 8, 2013

(51) Int. Cl. F02M 37/04; F02M 37/18; F02M 37/12

(52) U.S. Cl. CPC F02M 37/04; F02M 37/12; F02M 37/18
USPC 123/495; 417/313

(57) ABSTRACT

A combustion engine system and a method of operating the combustion engine system are disclosed. The combustion engine system includes a first fuel pump operatively coupled to a first prime mover and fluidly coupled to a fuel reservoir, a first power source operatively coupled to the first prime mover, the first power source including a first controller, a third fuel pump having an inlet that is fluidly coupled to a discharge of the first fuel pump, a first filter in fluid communication with the first fuel pump, a combustion engine fluidly coupled to a discharge of the third fuel pump and operative to convert fuel from the third fuel pump into shaft power. The first controller is configured to drive the first prime mover at a substantially constant power, independent of a rate of consumption of the fuel by the combustion engine.

### TECHNICAL FIELD

WWI This patent disclosure relates generally to combustion engine fuel systems and, more particularly, to low pressure liquid fuel transfer systems with fuel filtration.

### BACKGROUND

Combustion engines may utilize direct injection of high pressure liquid fuel, and a high pressure liquid fuel system may employ two or more fuel pumping stages in series to achieve the desired injection pressure. For example, common rail fuel systems for Diesel engines may include a fuel transfer pump that draws fuel from a fuel tank and delivers the fuel to the inlet of a high pressure common rail pump, which further increases the fuel pressure tote desired injection pressure.

High pressure liquid fuel systems have become more sensitive to particulate contamination with increasing fuel injection pressure. Further, the increased particulate sensitivity extends not only to the total volume fraction of particulates in the fuel, but also the maximum tolerable particle size. Indeed, fine particles in high pressure liquid fuel pumps or injectors can diminish fuel system performance or cause system failure through surface wear and scuffing, or heat-induced failure modes.

U.S. Patent Publication No. 2012/0073545 (hereinafter “the '545 publication”), entitled “Variable Flow Fuel Transfer Pump System and Method,” purports to address the problem of maximizing steady state fuel filtration efficiency and minimizing surge effects on filtration efficiency. The '545 publication describes a variable flow fuel transfer pump and a control system adapted to variably control the transfer pump based on fuel demand of the engine. However, the fuel supply system in the '545 publication may be prohibitively expensive or complex, and the control algorithms may be sensitive to engine-to-engine variations.

Accordingly, there is a need for improved combustion engine liquid fuel systems that provide adequate filtration performance at low cost and complexity, and with high reliability.

### SUMMARY

In one aspect, the disclosure describes a combustion engine system. The combustion engine system includes a first fuel pump operatively coupled to a first prime mover and fluidly coupled to a fuel reservoir, a first power source operatively coupled to the first prime mover, the first power source including a first controller, a second fuel pump having an inlet that is fluidly coupled to a discharge of the first fuel pump, a first filter in fluid communication with the first fuel pump, the first filter disposed upstream of the second fuel pump in a direction of fuel flow, a combustion engine fluidly coupled to a discharge of the second fuel pump and operative to convert fuel from the second fuel pump into shaft power. The first prime mover is distinct from the combustion engine, and the first controller is configured to drive the first prime mover at a substantially constant energy potential, independent of a rate of consumption of the fuel by the combustion engine.

In another aspect, the disclosure describes a liquid fuel pump module. The liquid fuel pump module includes a housing, a first fuel pump coupled to the housing, a first prime mover operatively coupled to the first fuel pump, a second fuel pump coupled to the housing, and a first power connector disposed on the first prime mover, the first power connector being operative to convey one of electrical, hydraulic, and pneumatic power to the first prime mover.

In yet another aspect, the disclosure describes a method of operating a combustion engine system. The method including operating a first fuel pump with a first power source before starting a combustion engine, starting the combustion engine, operating a second fuel pump using a second power source, controlling the second power source to provide a substantially constant energy potential, filtering a fuel flow through the combustion engine system, supplying the fuel flow from a discharge of the second fuel pump to an inlet of a third fuel pump, consuming a first fraction of the fuel flow in the combustion engine, and bypassing a second fraction of the fuel flow to a fuel reservoir.

### BRIEF DESCRIPTION OF THE DRAWINGS

FIG. 1 is a schematic diagram of a combustion engine fuel system according to an aspect of the disclosure.

FIG. 2 is a schematic diagram of a combustion engine fuel system according to another aspect of the disclosure.

FIG. 3 is a schematic diagram of a combustion engine fuel system according to yet another aspect of the disclosure.

FIG. 4 shows a cross sectional view of a low pressure fuel module according to an aspect of the disclosure.

### DETAILED DESCRIPTION

Throughout the drawings discussed herein, like reference numbers refer to like elements, unless otherwise specified.

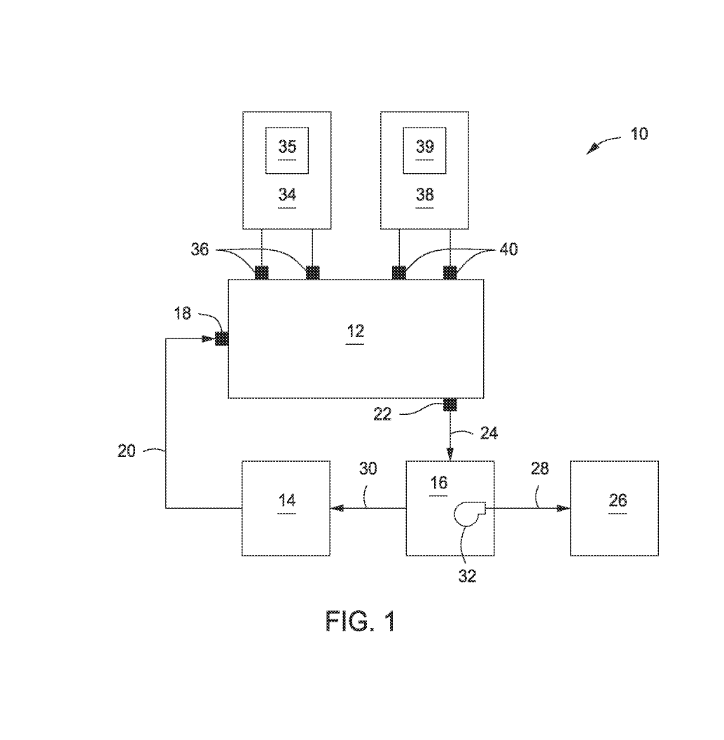

FIG. 1 is a schematic diagram of a combustion engine fuel system 10 according to an aspect of the disclosure. The combustion engine fuel system 10 includes a low pressure fuel module 12 fluidly coupled to a fuel tank or reservoir 14 and a high pressure fuel system 16. The low pressure fuel module 12 includes a fuel inlet connection 18 that is in fluid communication with the fuel tank 14 via a low pressure inlet conduit 20, and includes a fuel outlet connection 22 that is in fluid communication with the high pressure fuel system 16 via a low pressure outlet conduit 24.

The high pressure fuel system 16 may deliver a first portion of fuel flow from the low pressure outlet conduit 24 to a combustion engine 26 via the high pressure fuel supply conduit 28, and a second portion of fuel flow from the low pressure outlet conduit 24 back to the fuel tank 14 via a tank recirculation conduit 30. The high pressure fuel system 16 includes a high pressure fuel pump 32 that increases the pressure of the portion of the fuel flow to the combustion engine 26, via the high pressure fuel supply conduit 28, above the pressure in the low pressure outlet conduit 24. The combustion engine 26 may bum the first portion of fuel flow to convert chemical energy of the fuel into shaft power.

The low pressure fuel module 12 receives power from a first power source 34 via a first power connection 36. The low pressure fuel module 12 may also receive power from a second power source 38 via a second power connection 40. Either the first power source 34 or the second power source 38 may be, for example, a hydraulic power source, a pneumatic power source, an electrical power source, combinations thereof, or any other power source known to persons having ordinary skill in the art. Likewise, either the first power connection 36 or the second power connection 40 could include, for example, a hydraulic conduit, a pneumatic conduit, an electrical conductor, combinations thereof, or any other power connection known to persons having ordinary skill in the art.

The first power source 34 may include a first controller 35, and the second power source 38 may include a second controller 39. In one aspect of the disclosure, the first controller 35 and the second controller 39 may control an energy potential of the first power source 34 and the second power source 38, respectively. In another aspect of the disclosure, the first controller 35 and the second controller 39 may control an energy potential of the first power source 34 and the second power source 38, respectively, independent of a speed or fuel consumption of the combustion engine 26.

For example, when either the first power source 34 or the second power source 38 is a. hydraulic power source or a pneumatic power source, a hydraulic pressure or a pneumatic pressure thereof, respectively, may be controlled substantially independent of a speed of the combustion engine 26. Similarly, when either the first power source 34 or the second power source 38 is an electrical power source, a voltage thereof may be substantially independent of a speed of the combustion engine 26. Further, an energy potential of the first power source 34 or the second power source 38 may be controlled to be substantially constant, independent of the speed or load of the combustion engine 26.

Either the first power source 34 or the second power source 38 may be distinct from the combustion engine 26, such that, they are not incorporated into a structure of the combustion engine 26 block or head, for example, nor are they directly coupled to a shaft of the combustion engine 26. In one aspect, either the first power source 34 or the second power source 38 may receive power from a power source other than the combustion engine 26, such as, for example, a power storage unit which may include batteries or a tank pressurized by a fluid, or another engine that does not receive fuel from the high pressure fuel system 16.

Alternatively, it will be appreciated that either the first power source 34 or the second power source 38 may receive power, such as, for example, hydraulic power, pneumatic power, or electrical power from the combustion engine 26. Moreover, either the first power source 34 or the second power source 38 may include fluid regulating devices such as, for example, orifices or control valves; fluid energy filters such as, for example, accumulators; electrical regulating devices, such as, for example, voltage regulators; combinations thereof; or other energy potential or power regulating devices known to persons having ordinary skill in the art.

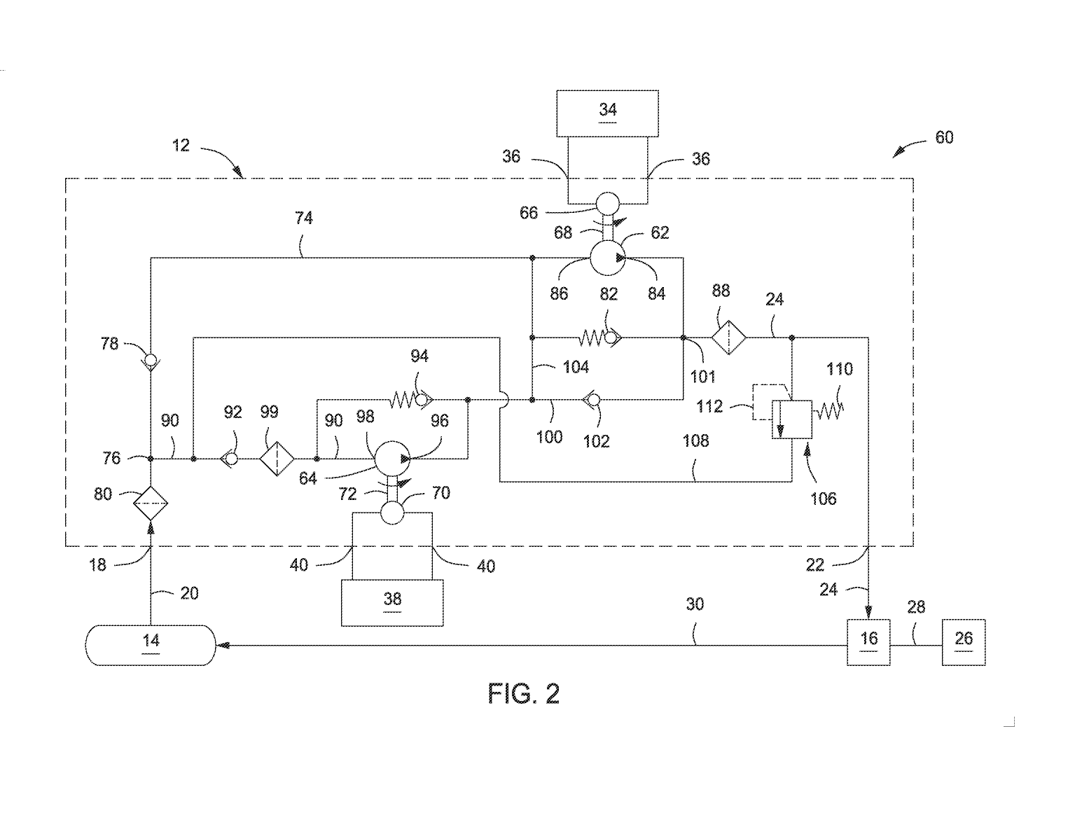

FIG. 2 is a schematic diagram of a fuel system 60 according to an aspect of the disclosure. Similar to FIG. 1, FIG. 2 includes a low pressure fuel module 12 that is fluidly coupled to a fuel tank 14 and a high pressure fuel system 16, a first power source 34, and optionally a second power source 38. However, fuel system 60 further includes a first fuel pump 62 and a second fuel pump 64.

The first fuel pump 62 is operatively coupled to a first prime mover 66 via a first shaft 68, and the second fuel pump 64 is operatively coupled to a second prime mover 70 via a second shaft 72. The first prime mover 66 receives power from the first power source 34 via the first power connection 36, and the second prime mover 70 receives power from the second power source 38 via the second power connection 40.

Either the first prime mover 66 or the second prime mover 70 could be a hydraulic motor, a pneumatic motor, an electric motor, or other device known to persons of ordinary skill for converting energy from one form into rotating or reciprocating shaft power. Although FIG. 2 shows the first prime mover 66 and the second prime mover 70 included within the low pressure fuel module 12, it will be appreciated that the first prime mover 66 and the second prime mover 70 may be disposed outside the low pressure fuel module 12 and transfer shaft power into the low pressure fuel module 12 via the first shaft 68, the second shaft 72, or both. Further, either the first prime mover 66 or the second prime mover 70 may be distinct from the combustion engine 26, such that they are not incorporated into a structure of the combustion engine 26 block or head, for example, nor are they coupled to the combustion engine 26 via direct shaft coupling, gear drive, or belt drive, for example.

As shown in FIG. 2, the first fuel pump 62 may be fluidly coupled to the fuel tank 14 via a first pump inlet conduit 74 and the low pressure inlet conduit 20, which are joined at a node 76. The first pump inlet conduit 74 may include a check valve 78, such that the check valve 78 is oriented to allow flow only in a direction from the fuel tank 14 to the first fuel pump 62. The low pressure fuel module may include an inlet filter 80 disposed in the low pressure inlet conduit 20. However, it will be appreciated that the inlet filter 80 may be disposed in the low pressure inlet conduit 20 outside the low pressure fuel module 12. The inlet filter 80 may include a water separator, filtration media, or combinations thereof, for example.

The low pressure fuel module 12 may include a spring-check valve 82 disposed in parallel with the first fuel pump 62, such that the spring-check valve 82 allows a flow from a discharge 84 of the first fuel pump 62 to an inlet 86 of the first fuel pump 62 when, and only when, a pressure difference between the discharge 84 and the inlet 86 overcomes a resilience of the spring-check valve 82, thereby decreasing a pressure at the discharge 84 of the first fuel pump 62. Accordingly, the spring-check valve 82 may act to limit pressure at the discharge 84 of the first fuel pump 62 by recirculating fuel around the first fuel pump 62.

The discharge 84 of the first fuel pump 62 may be in fluid communication with the high pressure fuel system 16 via the low pressure outlet conduit 24 and the fuel outlet connection 22. The low pressure outlet conduit 24 may include a filter 88. The second fuel pump 64 may be in fluid communication with the fuel tank 14 via a second pump inlet conduit 90 and the low pressure inlet conduit 20, which may be joined at the node 76. The second pump inlet conduit 90 may include a check valve 92, such that the check valve 92 is oriented to allow flow only in a direction from the fuel tank 14 to the second fuel pump 64.

Further, the low pressure fuel module 12 may include a spring-check valve 94 disposed in parallel with the second fuel pump 64, such that the spring-check valve 94 allows a flow from a discharge 96 of the second fuel pump 64 to an inlet 98 of the second fuel pump 64 when, and only when, a pressure difference between the discharge 96 and the inlet 98 overcomes a resilience of the spring-check valve 94, thereby decreasing a pressure at the discharge 96 of the second fuel pump 64. Accordingly, the spring-check valve 94 may act to limit pressure at the discharge 96 of the second fuel pump 64 by recirculating fuel around the second fuel pump 64. It will be appreciated that either the spring-check valve 82 or the spring-check valve 94 could toggle between fully open or fully closed positions, or alternatively, operate in a proportional manner over a continuous range of open flow areas. Optionally, the low pressure fuel module 12 may include a filter 99 disposed in the second pump inlet conduit 90.

The discharge 96 of the second fuel pump 64 is fluidly coupled to the discharge 84 of the first fuel pump 62 via a fluid conduit 100 and a check valve 102. Further, the fluid conduit 100 may be fluidly coupled to the low pressure outlet conduit 24 at the node 101. The check valve 102 is oriented to allow flow only in a direction from the discharge 96 of the second fuel pump to the discharge 84 of the first fuel pump 62. Optionally, the discharge 96 of the second fuel pump 64 may be fluidly coupled to the inlet 86 of the first fuel pump 62 via fluid conduit 104.

The low pressure fuel module 12 may include a relief valve 106 disposed in a relief conduit 108, such that the relieve valve selectively effects fluid communication between the discharge 84 of the first fuel pump 62 and the inlet 98 of the second fuel pump 64 or the inlet 86 of the first fuel pump 62. The relief valve 106 includes a resilient member 110 that biases the relief valve 106 toward a closed position. A pressure applied to the resilient member 110 via the pilot conduit 112 urges the relief valve 106 against the resilient member 110 toward an open position of the relief valve 106. The pilot conduit 112 may be in fluid communication with the low pressure outlet conduit 24 as the actuating pressure. Thus, the relief valve 106 may recirculate flow from the low pressure outlet conduit 24 to either the inlet 86 of the first fuel pump 62 or the inlet 98 of the second fuel pump 64 based on a pressure in the low pressure outlet conduit 24, thereby controlling pressure in the low pressure outlet conduit 24. It will be appreciated that the relief valve 106 could toggle between fully open or fully closed positions, or alternatively, operate in a proportional manner over a continuous range of open flow areas.

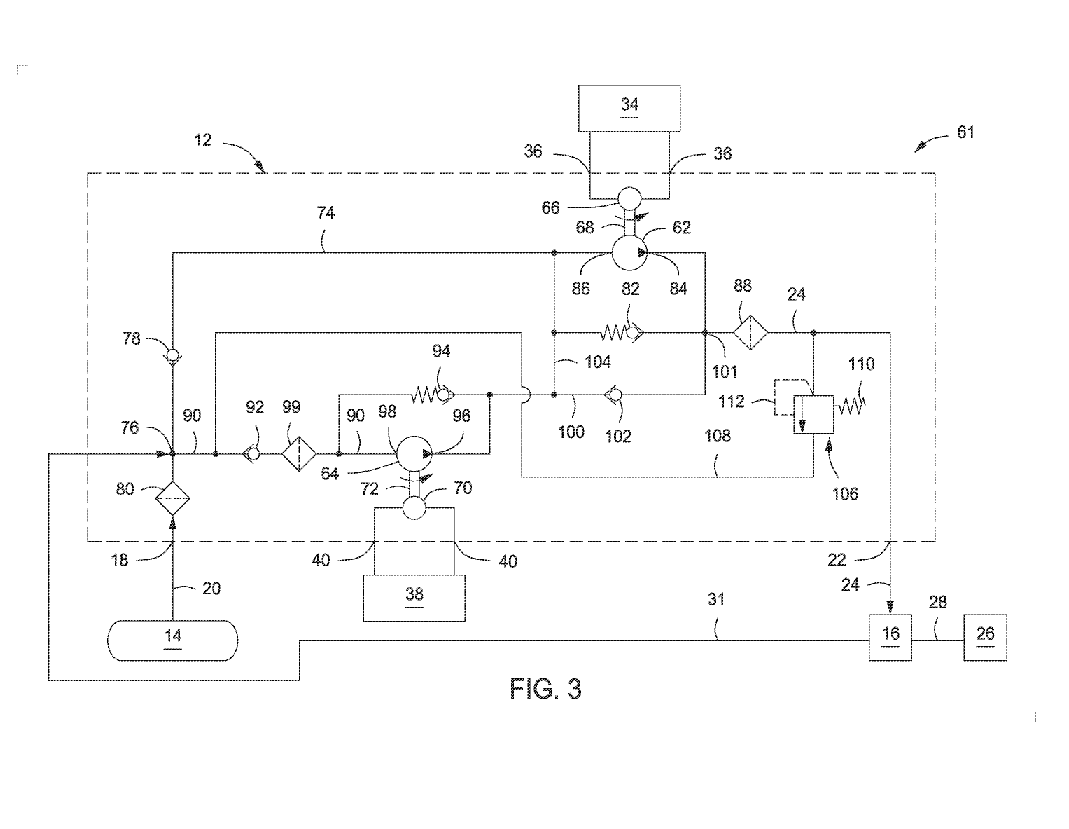

FIG. 3 shows a schematic diagram of a combustion engine fuel system 61 according to yet another aspect of the disclosure. The combustion engine fuel system 61 is similar to the combustion engine fuel system 60, shown in FIG. 2, except that a tank recirculation conduit 31 extends from the high pressure fuel system 16 to the node 76 instead of the fuel tank 14. Thus, the kidney loop may couple to the low pressure fuel module 12 downstream of the fuel tank 14 and upstream of either the inlet 86 of the first fuel pump 62 or the inlet 98 of the second fuel pump 64.

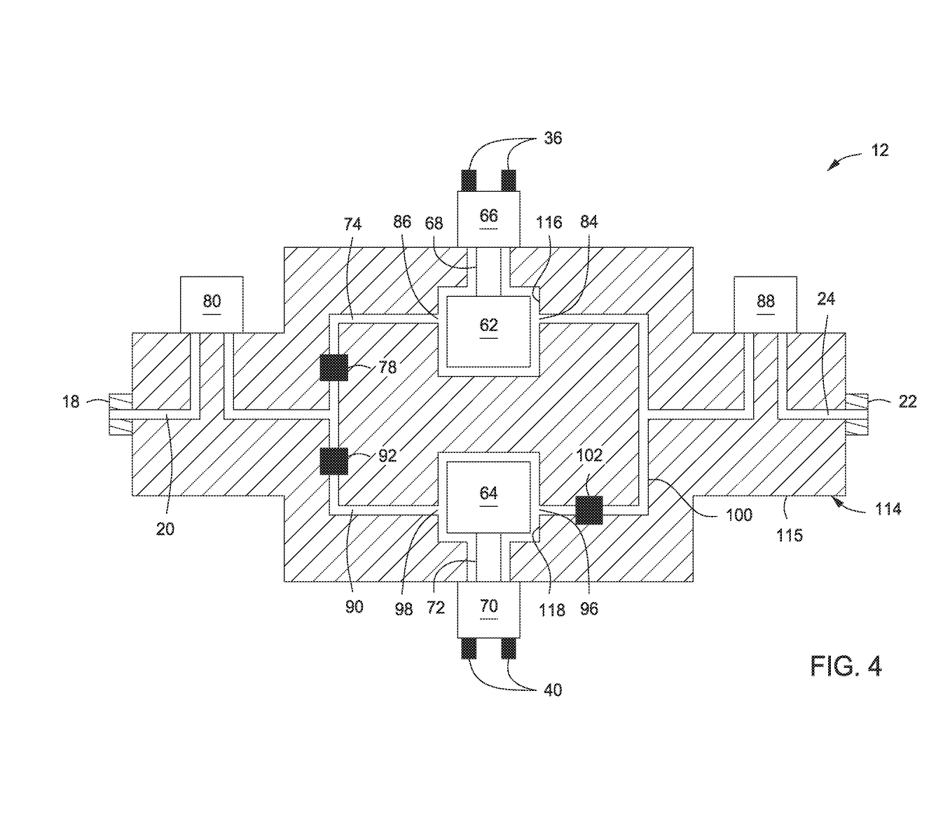

FIG. 4 shows a cross sectional view of a low pressure fuel module 12 according to an aspect of the disclosure. The low pressure fuel module 12 may include a main housing 114 that couples the fuel inlet connection 18, the first fuel pump 62, and the fuel outlet connection 22 together in one assembly. The main housing 114 may further couple the second fuel pump 64, the inlet filter 80, or the outlet filter 88 to the assembly, Moreover, it will be appreciated that the main housing 114 may define any of the fluid conduits within the low pressure fuel module 12 and include any features of the low pressure fuel module 12 as shown in FIG. 2, for example, and as previously described. Conversely, it will be appreciated that any of the fluid conduits shown as defined by interior features of the main housing 114 may be implemented as hoses or tithing attached to the exterior surface 115 without departing from the scope of the disclosure.

Although the main housing 114 is shown as one continuous structure in FIG. 4 it will be appreciated that the main housing 114 may include a plurality of subassembly structures connected by welding, fasteners, combinations thereof, or other approaches for joining mechanical elements known to persons having ordinary skill in the art. For example, a housing of either the first prime mover 66, the second prime mover 70, the inlet filter 80, or the outlet filter 88 may be incorporated as removable or non-removable parts of the main housing 114.

Further, while the first prime mover 66 and the second prime mover 70 are shown mounted to an exterior surface 115 of the main housing 114 in FIG. 4, it will be appreciated that either of the first prime mover 66 or the second prime mover 70 could be disposed within an internal surface of the main housing 114, and have their associated power connections 36, 40 disposed on the main housing 114. Conversely, while the first fuel pump 62 and the second fuel pump 64 are shown disposed within a first pump chamber 116 and a second pump chamber 118, each defined by the main housing 114, respectively, it will be appreciated that the first fuel pump 62 and the second fuel pump 64 may be mounted to an exterior surface 115 of the main housing 114.

In one aspect of the disclosure, the main housing 114 is free from contact with the combustion engine 2.6 (see FIG. 1). In another aspect of the disclosure, the main housing 114 is mounted on the combustion engine 26 as a distinct and separable unit. In yet another aspect of the disclosure, the main housing 114 is free from contact with the high pressure fuel pump (see FIG, 1). In still yet another aspect of the disclosure, the main housing 114 is mounted on the fuel tank 14 (see FIG. 2).

### INDUSTRIAL APPLICABILITY

The present disclosure is universally applicable to combustion engine fuel systems that employ fuel pumps and fuel filters, and more particularly, to combustion engine fuel systems that employ two or more pumps operating in series with at least one fuel filter. Such engine fuel systems may be applied to compression ignition engines such as Diesel engines, any reciprocating combustion engine employing direct injection of high pressure liquid fuel, fueled gas turbines, or other combustion engines known to persons having ordinary skill in the art that require high pressure liquid fuel. Further, the present disclosure is applicable to any machine incorporating one or more of the above-described combustion engines, such as, for example, locomotives, on-road vehicles, off-road vehicles, maritime vehicles, stationary power generation units, and other similar machines known to persons with ordinary skill in the art.

Increasing fuel injection pressures in compression ignitions engines may be beneficial to meeting increasingly stringent emissions requirements, and as fuel injection pressure increases, the degree of fuel cleanliness becomes increasingly more important with respect to fuel system component life. Fuel cleanliness may be improved by passing the fuel through multiple stages of fuel filters before delivery to the engine. Alternatively, the same fuel may be passed repetitively through fewer filter stages before delivery to the engine. Such repetitive cycling of fuel through a filter assembly may be referred to as “kidney loop” operation.

Applicants identified cost and packaging challenges associated with kidney loop operation that may result from increased fuel conduit sizes to sustain higher fuel flow rates with acceptable pressure drops to effect the repetitive fuel passes through the fuel filter fur kidney loop operation. These cost and packaging challenges are compounded by the distance from the low pressure fuel transfer pump to the fuel tank, which may be greatest when using a conventional engine-mounted low pressure fuel transfer pump.

Applicants have also identified fuel filtration performance challenges associated with engine-mounted low pressure fuel transfer pumps that are driven directly by the engine, such that the transfer pump speed varies with engine speed. Indeed, engine testing has revealed that variations in fuel flow through fuel filters tends to dislodge previously trapped particles, especially among the smaller particles, thereby allowing the dislodged particles to flow downstream to the high pressure fuel pump and the engine fuel injectors.

The above-noted challenges associated with conventional approaches are at least partially alleviated by aspects of the disclosure. First, uncoupling the low pressure transfer pump 62 from a combustion engine direct drive arrangement may allow the low pressure transfer pump 62 to be located closer to the fuel tank 14, thereby reducing the line size penalty for kidney loop operation and providing mechanical packaging flexibility. Second, driving the low pressure transfer pump 62 with a power source 34 having an energy potential that is independent of combustion engine 26 speed may enable the low pressure fuel module 12 to maintain a more constant fuel flow rate through the fuel filters 80, 88, with reduced hydraulic noise, thereby improving filtration performance by avoiding variations in fuel flow through the fuel filters 80, 88. In addition, the reduced hydraulic noise at the fuel outlet connection 22 of the low pressure fuel module 12 also promotes improved pressure control at the exit of the high pressure fuel pump 32 (see FIG. 1.).

Third, the constant flow operation of the low pressure fuel module 12 may provide Improved filtration performance without the added cost and complexity potentially associated with the system proposed in the '545 publication, as previously discussed. Indeed, aspects of the disclosure may obviate the need for expensive variable speed pumps and the corresponding complex controls described in the '545 publication. Further, aspects of the disclosure providing substantially constant energy potential to drive the low pressure fuel transfer pumps 62, 64 may effect substantially constant fuel flow through the low pressure fuel module 12, thereby also providing improved filtration performance over the '545 publication, for example, which is designed to intentionally vary the fuel flow through a fitter. Fourth, the modular nature of the low pressure fuel module 12 and its arrangement distinct from the combustion engine 26 may promote ease of maintenance for both the low pressure fuel module 12 and the combustion engine 26.

It will be appreciated that improved filtration performance offered by aspects of the disclosure may extend the life of components within the high pressure fuel system 16, including the high pressure fuel pump 32 and injectors on the combustion engine 26, by reducing particulates in the fuel entering the high pressure fuel system 16. Further, it will be appreciated that the improved filtration performance offered by aspects of the disclosure may allow engine operators to maintain comparable filtration performance using less sophisticated, less expensive, or lower pressure drop fuel filters.

Referring to FIG. 2, when the combustion engine 26 is not running, the second fuel pump 64 may be operated by a stored energy source in order to start the combustion engine 26, for example. According to one aspect of the disclosure, the second power source 38 may be an electrical power source, such as, for example, a battery. According to another aspect of the disclosure, the second power source may be a pneumatic power source, such as a tank pressurized with air. Thus, the second fuel pump 64 may provide fuel to the high pressure fuel system 16 independent of combustion engine 26 operation.

Then, after using the second fuel pump 64 to start the combustion engine 26, the first power source 34 may be a hydraulic power source that is driven by the combustion engine 26. Hydraulic controls associated with the engine and other work implements may operate to maintain the first power source 34 at a constant energy potential or hydraulic pressure. In addition, as previously discussed, the first power source 34 may include its own pressure regulating features to further control the energy potential applied to the first prime mover 66. Thus, the low pressure fuel module 12 may maintain a substantially constant flow of fuel through the filter 80, the filter 88, or both, and may deliver a substantially constant flow of fuel to the high pressure fuel system 16.

In another aspect of the disclosure, the first controller 35 and the second controller 39 may control a power output of the the first pump 62 and the second pump 64, respectively, where pump power output is proportional to flow through the pump times pressure rise across the pump. For example, the first controller 35 or the second controller 39 may receive signals indicative of fuel flow and fuel pressure rise through pump 62 and pump 64, respectively, and control the energy potential of the first power source 34 and the second power source 38 to maintain substantially constant fuel pumping power.

In yet another aspect of the disclosure, the first controller 35 and the second controller 39 may control a power consumption of the first prime mover 66 and the second prime mover 70, respectively, where power consumption is proportional to an energy potential across the prime mover times a current or flow through the prime mover. For example, if the first prime mover 66 were a hydraulic motor, the first controller could receive signals indicative of hydraulic fluid flow through the first prime mover 66 and a hydraulic fluid pressure drop across the first prime mover 66 and vary a pressure of the first power source 34 to maintain substantially constant power consumption by the first prime mover 66.

In one aspect of the disclosure, the second prime mover 70 is deenergized following starting or ignition of the combustion engine 26, such that only the first pump 62 supplies fuel flow to the high pressure fuel system 16. In another aspect of the disclosure, both the first prime mover 66 and the second prime mover 70 operate simultaneously while the combustion engine 26 is running. For example, the second controller 39 may determine that the fuel flow from the first fuel pump 62 is lower than desired, and in response, energize the second prime mover 70 to supplement the fuel flow from the first pump 62 with additional flow from the second pump 64. Thus, operating both the first pump 62 and the second pump 64 could extend a maintenance cycle to replace the filter 88, for example, when a pressure drop across the filter 88 significantly reduces fuel flow through the first fuel pump 62 acting alone.

A first portion of the fuel flow delivered to the high pressure fuel system 16 from the low pressure fuel module 12 is consumed by the combustion engine 26 as the combustion engine 26 converts chemical energy of the fuel into mechanical power. A second portion of the fuel flow delivered to the high pressure fuel system 16 is recirculated to the fuel tank 14, the inlet 98 of the second fuel pump 64, or the inlet 86 of the first fuel pump 62, thereby establishing kidney loop operation. However, unlike conventional approaches, the kidney loop operation according to aspects of the disclosure may maintain a substantially constant flow rate through the filters 80, 88 to promote filtration performance without expensive pumps or complex controls.

In one aspect of the disclosure, the ratio of the second portion of fuel flow recirculated to the fuel tank 14 to the first portion of fuel flow consumed by the combustion engine 26 is not less than about 4:1. In another aspect of the disclosure with a different configuration, the ratio of the second portion of fuel flow recirculated to the fuel tank 14 to the first portion of fuel flow consumed by the combustion engine 26 is not less than about 10:1. However, it will be appreciated that the low pressure fuel module 12 could be designed to effect any ratio of kidney loop recirculation flow to consumed engine fuel flow.

In one aspect of the disclosure, either the first fuel pump 62, the second fuel pump 64, or both, operates at a speed that is independent of a speed of a crankshaft of the combustion engine 26. In another aspect of the disclosure, either the first filet pump 62, the second fuel pump 64, or both, operates at a speed that is independent of a speed of the high pressure fuel pump 32.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. A combustion engine system, comprising
a first fuel pump operatively coupled to a first prime mover and fluidly coupled to a fuel reservoir;
a first power source operatively coupled to the first prime mover, the first power source including a first controller;
a second fuel pump having an inlet that is fluidly coupled to a discharge of the first fuel pump;
a first filter in fluid communication with the first fuel pump, the first filter disposed upstream of the second fuel pump in a direction of fuel flow;
a combustion engine fluidly coupled to a discharge of the second fuel pump and operative to convert fuel from the second fuel pump into shaft power,
the first prime mover being distinct from the combustion engine, and
the first controller being configured to drive the first prime mover at a substantially constant energy potential, independent of a rate of consumption of the fuel by the combustion engine.

2. The combustion engine system of claim 1, wherein the first filter is disposed downstream of the first fuel pump in the direction of fuel flow.

3. The combustion engine system of claim 1, further comprising a second filter in fluid communication with the first fuel pump, the second filter disposed upstream of the first fuel pump in the direction of fuel flow.

4. The combustion engine system of claim 1, wherein the first prime mover is a hydraulic motor, and the first power source is a hydraulic power source.

5. The combustion engine system of claim 4, wherein the hydraulic power source is driven by the combustion engine.

6. combustion engine system of claim 1, wherein a power input shaft of the first fuel pump is free to rotate independently from a power input shaft of the second fuel pump.

7. The combustion engine system of Claim I, wherein a power input shaft of the first fuel pump is free to rotate independently from a crankshaft of the combustion engine.

8. The combustion engine system of claim 1, further comprising an engine bypass conduit in fluid communication with the discharge of the first fuel pump and the fuel reservoir.

9. The combustion engine system of claim 1, further comprising a third fuel pump operatively coupled to a second prime mover and fluidly coupled to the fuel reservoir.

10. A liquid fuel pump module, comprising:
a housing;
a first fuel pump coupled to the housing;
a first prime mover operatively coupled to the first fuel pump;
a second fuel pump coupled to the housing; and
a first power connector disposed on the first prime mover, the first power connector being operative to convey one of electrical, hydraulic, and pneumatic power to the first prime mover.

11. The liquid fuel pump module of claim 10, further comprising a first fuel filter coupled to the housing, the first fuel filter being in fluid communication with the first fuel pump and the second fuel pump.

12. The liquid fuel pump module of claim 11, thither comprising a second fuel filter coupled to the housing, the second fuel filter being in fluid communication with the first fuel pump and the second fuel pump, the second fuel filter being disposed upstream of the first fuel pump in a direction of fuel flow.

13. The liquid fuel pump module of claim 10, wherein the first fuel pump is disposed within a first pump chamber defined by the housing.

14. The liquid fuel pump module of claim 13, wherein the second fuel pump is disposed within a second pump chamber defined by the housing.

15. The liquid fuel pump module of claim 10, wherein the first prime mover is a hydraulic motor.

16. The liquid fuel pump module of claim 10, further comprising:
a fuel inlet connector disposed on the housing, the fuel inlet connector being fluidly coupled to an inlet of the first fuel pump and an inlet of the second fuel pump; and
a fuel outlet connector disposed on the housing, the fuel outlet connector being fluidly coupled to a discharge of the first fuel pump and a discharge of the second fuel pump.

17. A method of operating a combustion engine system, comprising:
operating a first fuel pump with a first power source before starting a combustion engine;
starting the combustion engine;
operating a second fuel pump using a second power source;
controlling the second power source to provide a substantially constant energy potential to the first fuel pump;
filtering a fuel flow through the combustion engine system;
supplying the fuel flow from a discharge of the second fuel pump to an inlet of a third fuel pump;
consuming a first fraction of the fuel flow in the combustion engine; and
bypassing a second fraction of the filet flow to a fuel reservoir.

18. The method of claim 17, wherein a magnitude of the second fraction of the fuel flow is greater than at least four times a maximum fuel consumption rate of the combustion engine.

19. The method of claim 18, wherein a magnitude of the second fraction of the fuel flow is greater than at least ten times a maximum fuel consumption rate of the combustion engine.

20. The method of claim 17, wherein the filtering the fuel flow is performed downstream of the second fuel pump.
